(19) United States
(12) Patent Application Publication
(10) Pub. No.: US 2025/0196321 A1
(43) Pub. Date: Jun. 19, 2025

(54) DEVICE FOR SUPPORTING AT LEAST ONE ARM

(71) Applicant: OTTOBOCK SE & CO. KGAA, Duderstadt (DE)

(72) Inventors: Maximilian Anton MERKER, Duderstadt (DE); Simon KÄSMANN, Duderstadt (DE); Emese PAPP, Duderstadt (DE)

(21) Appl. No.: 18/845,530

(22) PCT Filed: Mar. 10, 2023
(86) PCT No.: PCT/EP2023/056152

§ 371 Date: Sep. 10, 2024

(30) Foreign Application Priority Data
Mar. 11, 2022 (DE) 10 2022 105 745.3

(51) Int. Cl. B25J 9/00; B25J 17/00

(52) U.S. Cl. CPC B25J 9/0006; B25J 17/00

(57) ABSTRACT

A device for supporting at least one arm of a user, the device comprising at least one carrier device (2) and at least one force transmission element (22), which is arranged on the carrier element (2) by means of a joint (16), wherein the joint (16) is arranged on a fastening device (10) and the carrier element (2) has a pocket (4) into which the fastening device (10) is inserted.

The invention relates to a device for supporting at least one arm of a user, the device having at least one carrier element and at least one force transmission element that is arranged on the carrier element by means of a joint.

Such a device is known, for example, from DE 10 2017 112 436 B4. Devices for supporting an arm of a user have been known from the prior art for many years and are used, for example, to support the user when they are carrying out work above their head. Preferably, a device described here has at least one actuator, especially preferably a passive actuator, which is configured to apply a force to an arm support element equipped, for example, with an arm shell for being placed on the user's arm. The force applied to the arm support element by the actuator ensures that an upward force, i.e. against gravity, acts on the arm arranged in the arm shell. This force requires a counter bearing that is formed by the waist strap. This renders it possible to introduce the counter force into the wearer's waist. To introduce the counter force that counters the force applied by the actuator into the waist strap, the force transmission element is utilized.

Such a device is known, for example, from US 2016/0081871 A1. It comprises a counter bearing element, which is designed in the form of a strap that can be placed around the user's torso. On it there are two support struts running along the back to the shoulder, each of which is connected above and to the side next to the user's shoulders with a joint, so that the arm can be lifted. Spring elements are arranged on the corresponding joints by way of which an upward force can be applied to the arm shells so that the arm can be supported, for example when lifting heavy objects or working above one's head. If the arms are to be lowered, a pressure must be applied to the arm shells via the arms, said pressure exceeding the force applied by the spring elements, so that the arms lower.

It has been shown to be very beneficial for the freedom of movement of the arm when the user is wearing the device if the force transmission element is arranged on the waist strap by means of a joint. Preferably, the joint is a ball-and-socket joint; however, embodiments are known in which the joint is a single hinge joint that allows a swivel movement of the force transmission element relative to the waist strap about a single swivel axis.

The joint is usually formed by a first joint part and a second joint part, which are arranged so that they can move relative to each other. The types of possible movement and the degrees of freedom of the movement depend on the type of joint selected. In preferred embodiments, the first joint part is formed by a first end of the force transmission element or is arranged thereon. This first joint part is then arranged in a mount that forms the second joint part and is preferably connected to the waist strap. The first joint part can be, for example, the ball of a ball-and-socket joint or a pin of a hinge. The second joint part is then, for example, the ball mount or socket of the ball joint or the bushing of a hinge. The mount is extremely important for the force fit, as the force dissipated by the force transmission element is to be dissipated via the joint and thus via the second joint part, i.e. the mount, into the waist strap. It is therefore essential that the connection between the second joint section and the waist strap is as secure and firm as possible.

The devices described here are usually used to support the user while performing tasks common to the automotive industry or aircraft manufacturing, for example. Further fields of application examples include, for example, manual activities performed above one's head, such as painting, or activities for which tools, such as drills, have to held in a raised position over a sustained period of time. The devices are often exposed to contaminations which renders cleaning necessary or at least desirable.

The disadvantage is that it is difficult to clean the device.

The invention is therefore based on the task of further developing a device of the type described here in such a way that the disadvantages of the prior art are eliminated or at least reduced.

The invention solves the task addressed by way of a device according to the preamble of claim 1, which is characterized in that the joint is arranged on a fastening device and the carrier element has a pocket into which the fastening device is inserted.

The pocket is preferably arranged on an outer side of the carrier element, i.e. the side facing away from the user's body, preferably from the user's torso, when the device is in the mounted state. This means that the device does not disturb the user in this state. The fastening device is inserted in the pocket in the mounted state. A separate fastening within the pocket, for example by way of form-fitting elements such as a velcro fastener or at least one push button, is possible, but not essential. Consequently, to arrange the fastening device in the pocket, it is inserted into the pocket along a direction of movement. The necessary movement of the fastening device is preferably a linear movement without a change of direction. To remove the fastening device from the pocket, the fastening device is displaced in the direction opposite the direction of movement. To this end, it is advantageous, but not necessary, to not provide any further fasteners of the fastening device in the pocket. This makes it especially easy to dismantle the device and clean textile elements, for example. The carrier element is preferably a washable element, particularly preferably a purely textile element.

Preferably, the carrier element is arranged in or extends towards the user's pelvic area when the device is in the mounted state. In this case, the carrier element is a preferably a waist strap, a jacket, a pair of trousers and/or a vest or features a waist strap, a jacket, a pair of trousers and/or a vest. Preferably, the force transmitted by the force transmission element is introduced into the carrier element and from there into the user's pelvic area. The carrier element is preferably supported by the user's waist and/or pelvis.

The fastening device is preferably designed as a fastening plate.

In an advantageous embodiment, the pocket is designed as a frame or partial frame. A pocket designed as a frame has a circumferential edge, which is designed to be rectangular, for example. It is firmly connected, for example sewn or glued, to the carrier element across one part of the circumference. This part of the circumference is referred to as the fixed part. Across another part of the circumference, the edge or frame is not connected to the carrier element, but forms the opening of the pocket through which the fastening device can be inserted. This part of the circumference is referred to as the opening part. The opening part is preferably smaller than the fixed part. If the pocket is rectangular, triangular or a polygonal, the opening part is preferably formed by one of the paths of the circumference. In the case of a rectangular pocket, it is advantageous if three sides of the edge form the fixed part and the remaining fourth side forms the edge of the opening part.

A pocket designed as a partial frame does not have a completely circumferential edge. This pocket can also be designed to be rectangular, wherein there is preferably no edge along one side, preferably a long side. In one preferred embodiment, the partial frame corresponds to the fixed part of a pocket designed as a frame.

The edge of a pocket designed as a frame or partial frame is, for example, a belt or strap with a width. The width is defined transversely to the longitudinal extension and, in the case of a belt or strap, is the direction with the second largest expansion. This edge is connected to the carrier element across part of the width insofar as said carrier element forms the fixed part of the edge. The radially outward part of the strap is preferably connected, in particular sewn or glued, to the carrier element. The fastening device is inserted between this edge and the carrier element.

Preferably, the device has at least one sealing element, such as a tab, by means of which the pocket can be sealed. Once the fastening device has been inserted into the pocket, the pocket can preferably be sealed by the tab. To this end, the tab is placed over the opening of the pocket and, for example, fixed to the pocket or carrier element. This means that the fastening device inserted in the pocket cannot simply be pulled out of the pocket by moving it in the opposite direction to the insertion. To remove the fastening device from the pocket, the tab first has to be opened.

The tab preferably has at least one form-fitting element, for example a velcro element and/or a push button. A corresponding counter element is arranged on the carrier element and/or the pocket. If the tab is closed, the form-fitting element of the tab engages with the corresponding counter element, thereby establishing a form-fitting connection.

In one preferred embodiment, the joint can be positioned on the fastening device in various positions and/or in various orientations. To this end, the joint, preferably the part of the joint to be positioned on the fastening device, has a fastening element, preferably a form-fitting element. This may be a velcro element, a push button or a clip element. A corresponding counter element is preferably located on the outside of the fastening device on which the joint is to be arranged. The joint can be positioned on the fastening device by engaging the two elements. The form-fitting elements and counter elements can allow discrete positioning. This means that different positions and/or different orientations are possible, but they are not infinitely adjustable. This is achieved, for example, with clip elements and/or push buttons. Alternatively, continuous positioning may be possible if, for example, velcro elements are used. This means that the position and/or the orientation can be infinitely selected within predetermined limits.

In one preferred embodiment, the fastening device is made of a plastic. This results in sufficient stability. Particularly preferably, it is a plastic that possesses plastic ductility, so that the shape of the fastening device can be adapted to the contours of the wearer's body.

Alternatively, the fastening device is at least partially, but preferably completely, made of an elastically deformable material.

Preferably, the fastening device is anatomically shaped. In this case, the fastening device is adapted to the part of the device user against which the fastening device rests when the device is in the mounted state or on which it will be placed. The adaptation may be a standard adaptation which is adapted to the body shapes and/or dimensions of a standardized user. For example, the standard can be an average body shape or body part shape of the respective body part. A standardized anatomical shape is sufficient, particularly if the fastening device possesses plastic ductility. Although the fastening device is then not adapted exactly to the individual fit of the user's body part, it follows a standard shape of this body part, so that only minor changes to the shape of the fastening device will probably have to be made in order to customize it to the user. Alternatively, the fastening device is preferably adapted to the individual shape of a body part of the device user.

In one preferred embodiment, the fastening device is inserted sideways into the pocket. Particularly preferably, this means that the fastening device is inserted into the pocket along the longitudinal direction of the carrier element. Alternatively, it is also possible that the fastening device is inserted into the pocket from above, i.e. following the force of gravity in the mounted state. This embodiment has the advantage that the fastening device can be prevented from slipping out of the pocket more securely, even without a sealing element.

The pocket and the fastening device are preferably designed in such a way that the fastening device can be locked in the pocket in multiple positions. This allows the position of the joint arranged on the fastening device to be adjusted. This is particularly advantageous if only one shape and type of fastening device is to be provided for various sizes of various users. Individual adjustability can then be achieved if various positions of the fastening device are possible within the pocket as an alternative or in addition to the alterable position and/or orientation of the joint on the fastening device.

Preferably, the fastening device can be locked in the pocket in that a form-fitting element of the pocket engages with a counter element of the fastening device. To this end, the fastening device may comprise one or multiple projections, for example, and a corresponding depression arranged in the inner contour of the pocket.

The joint preferably refers to a ball-and-socket joint. Alternatively, the joint is a swivel element. The joint preferably has a first joint part and a second joint part, which are movably arranged against each other. However, the first joint part is advantageously arranged on a first end of the force transmission element or is formed by said element. The second joint part is fixed or at least can be fixed to the fastening device and preferably constitutes a mount for the first joint part.

In one preferred embodiment, the second joint part and the fastening device are designed as a single piece. Regardless of whether the fastening device forms a single piece with the second joint part or not, there is preferably a slot or groove between the fastening device and the second joint part. The pocket preferably has a recess that is adapted to the geometric design of the slot or groove. In this way, the edge of the recess of the pocket is inserted into the slot or groove when the fastening device is inserted into the pocket. This results in a form-fit connection between the fastening device and the second joint part on the one hand and the pocket on the other.

If the pocket has a sealing element, it is advantageous if it is inserted into the slot or groove once the pocket has been sealed by means of the sealing element.

Preferably, the sealing element, for example the tab, is designed to be u-shaped. Particularly preferably, the joint is located between the legs of the sealing element when the pocket is sealed by the sealing element. This design of the sealing element means on the one hand that the contact surface with which the sealing element rests against the pocket or carrier element is enlarged, which is particularly advantageous if the sealing element and the pocket or carrier element are connected via a velcro fastener; on the other hand, the connection between the sealing element and the pocket or carrier element are preferably only subjected to shear stress and cannot be opened or cannot be opened so easily by ‘peeling’ when the joint exerts a corresponding force.

In the following, an embodiment example of the invention will be explained in more detail with the aid of the accompanying diagrams. They show

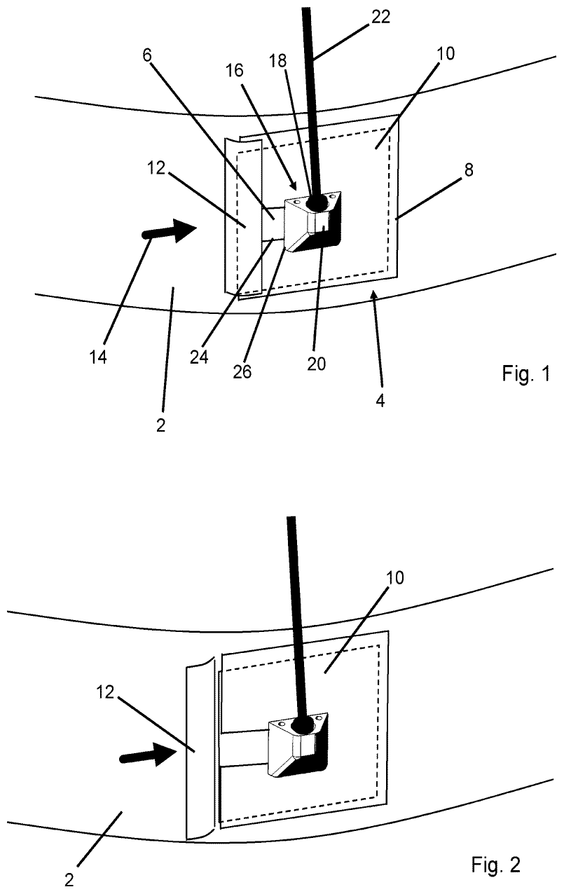

FIG. 1—the schematic representation of a part of a device according to an embodiment example of the present invention with a closed pocket,

FIG. 2—the representation from FIG. 1 with an open tab,

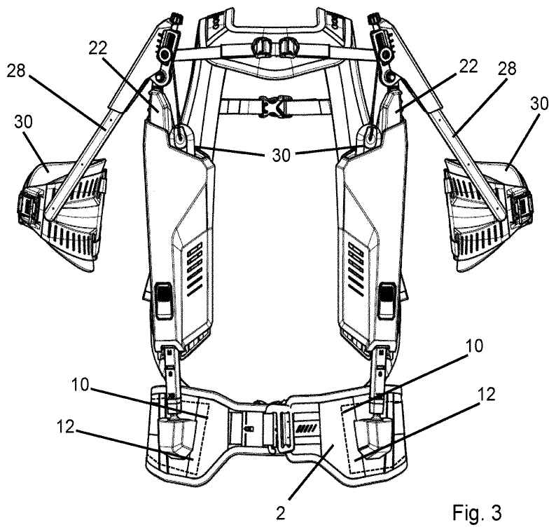

FIG. 3—the schematic representation of a device according to a further embodiment example of the present invention,

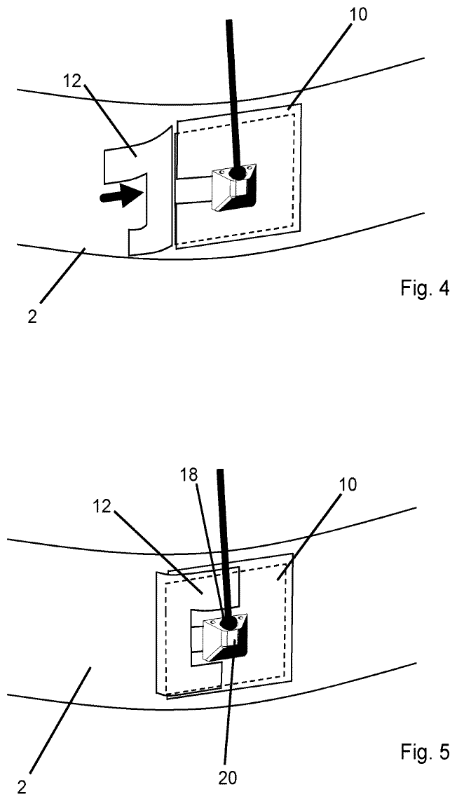

FIG. 4, 5—representations according to FIGS. 1 and 2 with a different tab shape,

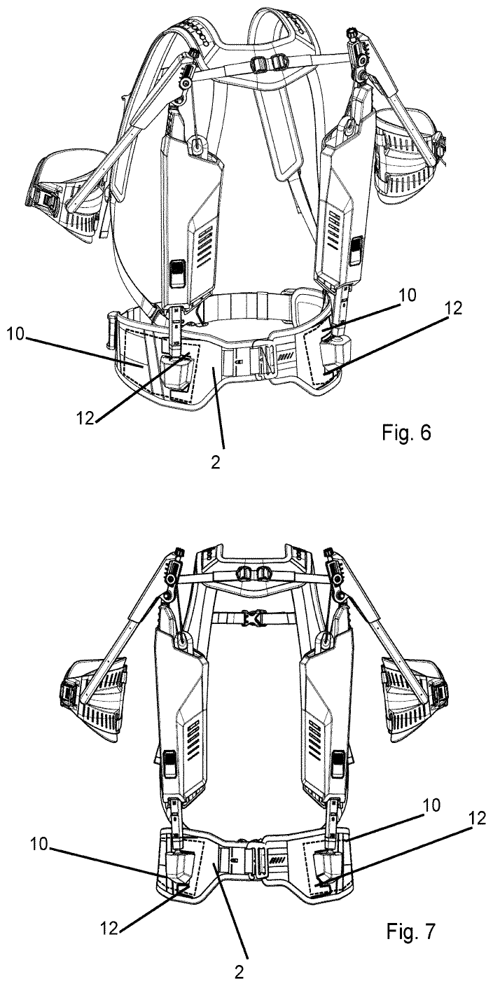

FIG. 6, 7—two different views of a device according to a further embodiment example of the present invention.

FIG. 1 depicts part of a device for supporting at least one arm of a user. It shows a waist strap which, in the embodiment example shown, forms the carrier element 2 and is placed around the user's torso in the mounted state. It has a pocket 4, which is designed as a frame and has a window 6. The window 6 is a recess provided in the pocket 4. The pocket 4 thus has a broad edge 8 that is connected to the material of the waist strap 2 on three sides—at the top, bottom and to the right in the embodiment example shown. On the fourth side—to the left in the embodiment example shown—the edge 8 is not connected to the waist strap 2, but forms the opening of the pocket 4. A fastening device 10 is inserted through said opening into the pocket 4. The fastening device is represented by the dashed line. Once the fastening device 10 had been inserted into the pocket 4, the opening of the pocket 4 was sealed by the tab 12.

The tab 12 is arranged on the edge 8 of the pocket 4 designed as a frame via a form-fitting element, not depicted here, thus preventing the fastening device 10 from accidentally slipping out of the opening of the pocket 4. The fastening device 10 is inserted into the pocket 4 along the arrow 14. The tab 12 is fixed to the carrier element 2, i.e. primarily the waist strap 2, with—in FIG. 1—its left-hand edge.

A joint 16, which comprises a first joint part 18 and a second joint part 20, is located on the fastening device 10. In the embodiment example shown, the joint part 18 is designed as the ball of a ball-and-socket joint and arranged on the first end of the force transmission element 22. The second joint part 20, on the other hand, forms the mount for the ball and is fixed to the fastening device 10. The second joint part 20 and therefore the joint 16 protrudes outwards, i.e. away from the wearer of the device, through the window 6 of the pocket 4.

In the embodiment example shown in FIG. 1, the window 6 has an edge 24 that is inserted into a groove 26, which is located between the fastening device 10 and the second joint part 20. This results in a form-fitting connection. FIG. 2 depicts the embodiment from FIG. 1 with an open tab 12. When the tab 12 is in this state, the fastening device 10 can be inserted into or removed from the pocket 4.

FIG. 3 schematically depicts a device according to an embodiment example of the present invention. It has two arm support elements 28, on each of which an arm shell 30 is arranged that can be arranged on the arm of the device user. In each case, a force is applied to the respective arm support element 28 via an actuator 32, which comprises an elastic element in the embodiment example shown. The force is transmitted to the carrier element, which is also a waist strap 2 in this embodiment, via the force transmission elements 22.

The waist strap 2 has two pockets 4, into each of which one fastening device 10 is inserted, represented by the dashed line. In addition, one can recognize that the tabs 12 protrude below the joint parts 20. To this end, the tabs 12 are inserted into the groove situated between the fastening device and the actual second joint part 20.

The representations in FIGS. 4 to 5 correspond to FIGS. 1 and 2. The main difference is in the design of the tab 12, which is u-shaped in the representation in FIGS. 4 and 5. The fastening device 10 is depicted in the same way as the embodiment shown in FIGS. 1 and 2. In FIG. 5, which illustrates the closed state in which the tab 12 seals the fastening device 10, one recognizes that the joint 16, which comprises the first joint part 18 and the second joint part 20 in the embodiment example shown, is positioned between the legs of the u-shaped tab 12.

FIGS. 6 and 7 show a device according to an embodiment example of the present invention from different perspectives. The representations largely correspond to FIG. 3 but differ from it by the u-shaped tab 12.

### REFERENCE LIST

2 waist strap
4 pocket
6 window
8 edge
10 fastening device
12 tab
14 arrow
16 joint
18 first joint part
20 second joint part
22 force transmission element
24 edge
26 groove

1. A device for supporting at least one arm of a user, comprising:
at least one carrier element;
a joint; and
at least one force transmission element arranged on the at least one carrier element by the joint,
wherein the joint is arranged on a fastening device, and
wherein the at least one carrier element has a pocket into which the fastening device is inserted or insertable.

2. The device according to claim 1, wherein the at least one carrier element is arranged in or extends to the user's pelvic area when the device is in a mounted state, wherein the at least one carrier element comprises or is one or more of a waist strap, a jacket, a pair of trousers, and a vest.

3. The device according to claim 1, wherein the pocket is designed as a frame or a partial frame.

4. The device according to claim 1 further comprising at least one sealing element which seals or is configured for sealing the pocket.

5. The device according to claim 1 wherein the joint is arrangeable on the fastening device in various positions and/or in various orientations.

6. The device according to claim 1 wherein the fastening device is made of a plastic.

7. The device according to claim 1 wherein the fastening device is anatomically shaped.

8. The device according to claim 1 wherein the fastening device is inserted or is insertable sideways into the pocket.

9. The device according to claim 1 wherein the pocket and the fastening device are designed such that the fastening device is lockable or placeable in multiple positions in the pocket.

10. The device according to claim 1 wherein the fastening device comprises a counter element that is engaged by or engageable by a form-fitting element of the pocket.

11. The device according to claim 1 wherein the joint is a ball-and-socket joint.

12. The device according to claim 1 wherein the joint comprises a first joint part and a second joint part which are movably arranged against each other, wherein
the first joint part is arranged at a first end of the at least one force transmission element or is formed by the first end of the at least one force transmission element, and
the second joint part is fixed or fixable to the fastening element.

13. The device according to claim 12, wherein the second joint part and the fastening device are designed as a single piece.

14. The device according to claim 4 wherein the sealing element is designed to be u-shaped.

15. The device according to claim 14 wherein the joint is positioned between legs of the u-shaped sealing element when the pocket is sealed by the sealing element.
